(19) United States
(12) Patent Application Publication
(10) Pub. No.: US 2008/0291911 A1
(43) Pub. Date: Nov. 27, 2008

(54) Method and apparatus for setting a TCP retransmission timer

(75) Inventors: Albert Lee, Aliso Viejo, CA (US); Mahadevan Kulathu Iyer, Thane (IN)

Correspondence Address: Albert Lee, 51 Sprucewood, Aliso Viejo, CA, 92656, US

(73) Assignee: IST International, Inc.

(21) Appl. No.: 11/804,935

(22) Filed: May 21, 2007

(51) Int. Cl. H04L 12/56

(52) U.S. Cl. 370/389

(57) ABSTRACT

A retransmission timer of a Transmission Control Protocol (TCP) session is set based at least in part on the predicted mean round trip time differential of the TCP session. For example, in one embodiment, after receiving a non-duplicate acknowledgment, the predicted mean round trip time differential of the TCP session would be determined and used to further determine the predicted round trip time of the next transmitted data segment. In one embodiment, the predicted round trip time of the next transmitted data segment would be used to determine a retransmission timeout, the value of which would be inserted into a retransmission timer.

### CROSS-REFERENCE TO RELATED APPLICATION

This application claims the benefit of U.S. Provisional Patent Application Ser. No. 60/630,896, filed Nov. 24, 2004, the disclosure of which is herein expressly incorporated by reference.

### FIELD OF THE INVENTION

The invention relates, in general, to reliable end-to-end communications and, more particularly, to setting the retransmission timer of a Transmission Control Protocol (TCP) session based at least in part on a predicted mean round trip time differential.

### BACKGROUND OF THE INVENTION

A packet-switched data network (such as the Internet) operates by segmenting data into packets and then transmitting these packets across a network or series of networks to their destination. It provides a more efficient allocation of bandwidth and capacity than a traditional circuit-switched network (such as a public switched telephone network) which creates circuits of fixed bandwidth and capacity.

Packet-switched data networks are commonly represented as multi-layer protocol stacks. Examples include the 7 layer Open System Interface (OSI) model and the 4 layer Transmission Control Protocol/Internet Protocol (TCP/IP) model. According to these models, each layer communicates only with the layers directly above and below it. One advantage of these models is that the interfaces between layers may be specified such that a layer created by one manufacturer can interface with a higher or lower layer created by another manufacturer. For example, an Internet Protocol (IP) layer created by a network card manufacturer pursuant to the TCP/IP protocols detailed in a series of Standards and Requests For Comments (RFCs) should be compatible with a TCP layer created by an operating system manufacturer, and vice-versa.

The ordering of the layers in the OSI model from highest to lowest is: (1) the application layer, (2) the presentation layer, (3) the session layer (4) the transport layer, (5) the network layer, (6) the data-link layer, and (4) the physical layer. The ordering of the layers in the TCP/IP model from highest to lowest is: (1) the application layer, (3) the transport layer (usually TCP), (3) the internet layer (usually IP), and (4) the network access layer. While this is the most common model, not all TCP/IP implementations follow this model. Also, while the TCP/IP model does not follow the OSI model, the TCP/IP transport layer may be mapped to the OSI transport layer and the TCP/IP internet layer may be mapped to the OSI network layer. Therefore, the data-link and physical layers in the OSI model may be considered lower layers than the transport and internet layers in the TCP/IP model. A brief discussion of the transport, network, data-link, and physical layers follows.

The transport layer is responsible for fragmenting the data to be transmitted into appropriately sized segments for transmission over the network. TCP is a transport layer protocol. The transport layer may provide reliability and congestion control processes that may be missing from the network layer.

The network layer is responsible for routing data packets over the network. IP is a network layer protocol.

The data-link layer manages the interfaces and device drivers required to interface with the physical elements of the network. Examples of the data-link layer include the Ethernet protocol and the Radio Link Protocol (RLP).

The physical layer is composed of the physical portions of the network. Examples include serial and parallel cables, Ethernet and Token Ring cabling, antennae, and connectors.

The operation of a TCP/IP network is as follows: An application (e.g. a web browser) that needs to send data to another computer passes data to the transport layer. At the transport layer, the data is fragmented into appropriately sized segments. These segments are then passed to the network layer where they are packaged into datagrams containing header information necessary to transmit the segments across the network. The network layer then calls upon the lower level protocols (e.g. Ethernet or RLP) to manage the transmission of the data across a particular physical medium. As the datagrams are transmitted from one network to another, they may be fragmented further. At the receiving computer, the process is reversed. The lower level protocols receive the datagrams and pass them to the network layer. The network layer reassembles the datagrams into segments and passes the segments to the transport layer. The transport layer reassembles the segments and passes the data to the application.

IP is limited to providing enough functionality to deliver a datagram from a source to a destination and does not provide a reliable end-to-end connection or flow control. There is no guarantee that a segment passed to a network layer using IP will ever get to its final destination. Segments may be received out of order at the receiver or packets may be dropped due to network or receiver congestion. This unreliability was purposefully built into IP to make it a simple, yet flexible protocol.

TCP uses IP as its basic delivery service. TCP provides the reliability and flow control that is missing from IP. TCP/IP Standard 7 states that “very few assumptions are made as to the reliability of the communication protocols below the TCP layer” and that TCP “assumes it can obtain a simple, potentially unreliable datagram service from the lower level protocols” such as IP. To provide the reliability that is missing from IP, TCP uses the following tools: (1) sequence numbers to monitor the individual bytes of data and reassemble them in order, (2) acknowledgment (ACK) flags to tell if some bytes have been lost in transit, and (3) checksums to validate the contents of the segment (NOTE: IP uses checksums only to validate the contents of the datagram header).

In addition, TCP provides flow control due to the fact that different computers and networks have different capacities, such as processor speed, memory and bandwidth. For example, a web enabled mobile phone will not be able to receive data at the same speed at which a web server may be able to provide it. Therefore, TCP must ensure that the web server provides the data at a rate that is acceptable to the mobile phone. The goal of TCP's flow control system is to prevent data loss due to too high a transfer rate, while at the same time preventing under-utilization of the network resources.

Originally, most TCP flow control mechanisms were focused on the receiving end of the connection, as that was assumed to be the source of any congestion. One example of a receiver-based flow control mechanism is receive window (rwnd) sizing. The size of rwnd is advertised by a receiver in the ACKs that it transmits to the sender. The size of rwnd is based on factors such as the size of the receiver's receive buffers and the frequency at which they are drained.

However, flow control mechanisms based on the receiver do not address problems that may occur with the network. Such problems may be network outages, high traffic loads and overflowing buffers on network routers. A receiver may be operating smoothly, but the network may be dropping packets because the sender is transmitting data at too high a rate for the network to handle. Therefore, sender-based flow control methods were developed. RFC 2581 details TCP's four flow control methods: (1) slow start, (2) congestion avoidance, (3) fast retransmit, and (4) fast recovery.

The four flow control methods are used to recover from, or to prevent, congestion related problems. Which method is used depends on which congestion related problem is encountered or to be prevented Slow start is used at the start of a connection to probe the network capacity or after a retransmission timer indicates that a segment has been lost. When a segment is transmitted or an ACK is received, the TCP sender predicts the round trip time of the next segment and calculates the retransmission timeout. When the next segment is transmitted, the retransmission timer for that segment is started with the new value of the retransmission timeout. If the retransmission timer expires before the ACK for that segment is received, then the segment is presumed lost. Congestion avoidance is used after slow-start reaches a predetermined threshold or after potential congestion is detected by the receipt of a duplicate ACK. Fast retransmit is used to retransmit a potentially lost packet before the retransmission timer indicates that it is lost. Fast recovery is used to prevent unnecessary retransmission of data.

While TCP's flow control methods generally work well, they were designed with the assumption that any packet loss experienced during a TCP session would be due to network or receiver congestion and not packet corruption. For TCP sessions over networks that consist entirely of wired networks, this is generally the case. However, for TCP sessions over networks wherein one of the networks is a wireless network, this is generally not the case. Wireless networks, such as cellular data networks, contain lossy links where packet loss due to corruption of the packet is a more common occurrence than it is on most wired networks. To compensate for packet loss due to packet corruption, many of these lossy links employ data-link and physical link protocols that provide for retransmission of lost packets outside of TCP's retransmission methods. However, the increased round trip time of a segment due to these retransmissions may increase the calculated retransmission timeout. This in turn may lead to delays in retransmitting packets that are truly lost. In addition, the increased round trip time of a segment due to these retransmissions may cause the retransmission timer to timeout and thus indicate that serious congestion exists when, in fact, it does not.

Accordingly, there is a need in the art to improve the setting of the retransmission timer of a TCP session.

### BRIEF SUMMARY OF THE INVENTION

A method and apparatus for setting a retransmission timer of a Transmission Control Protocol (TCP) session is disclosed. In one embodiment, the method includes determining a current round trip time differential for the TCP session based at least in part on a round trip time of one or more data segments associated with a non-duplicate acknowledgment. The method further includes determining a predicted mean round trip time differential of the TCP session based at least in part on the current round trip time differential. In one embodiment, the method also includes determining a predicted round trip time for a TCP segment based at least in part on the predicted mean round trip time differential. In addition, the method may also include determining the retransmission timeout of the TCP session based at least in part on the predicted round trip time, and setting the retransmission timer to the retransmission timeout.

Other aspects, features, and techniques of the invention will be apparent to one skilled in the relevant art in view of the following detailed description of the invention.

### BRIEF DESCRIPTION OF THE DRAWINGS

FIGS. 1A-1B depict simplified system diagrams of a system wherein one or more aspects of the invention may be performed, according to one or more embodiments;

FIG. 2 depicts an additional system-level embodiment of a system wherein one or more aspects of the invention may be performed, according to one or more embodiments; and

FIGS. 3A-3B are flow diagrams of how a TCP module may determine the predicted mean round trip time differential of a TCP session and set the retransmission timer of a TCP session, according to one or more embodiments.

### DETAILED DESCRIPTION OF EXEMPLARY EMBODIMENTS

A method and apparatus for setting the retransmission timer in a Transmission Control Protocol (TCP) session are disclosed. One aspect of the invention is to provide a flexible method for determining the predicted round trip time differential of a TCP session. Another aspect of the invention is to provide a method for determining the predicted round trip time of a TCP segment. Yet another aspect of the invention is to determine the value of the retransmission timeout of a TCP session and set the retransmission timer to this value.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits. The terms “network node”, “sender”, and “receiver” are understood to include any electronic device that contains a processor, such as a central processing unit.

When implemented in software, the elements of the invention are essentially the code segments to perform the necessary tasks. The code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

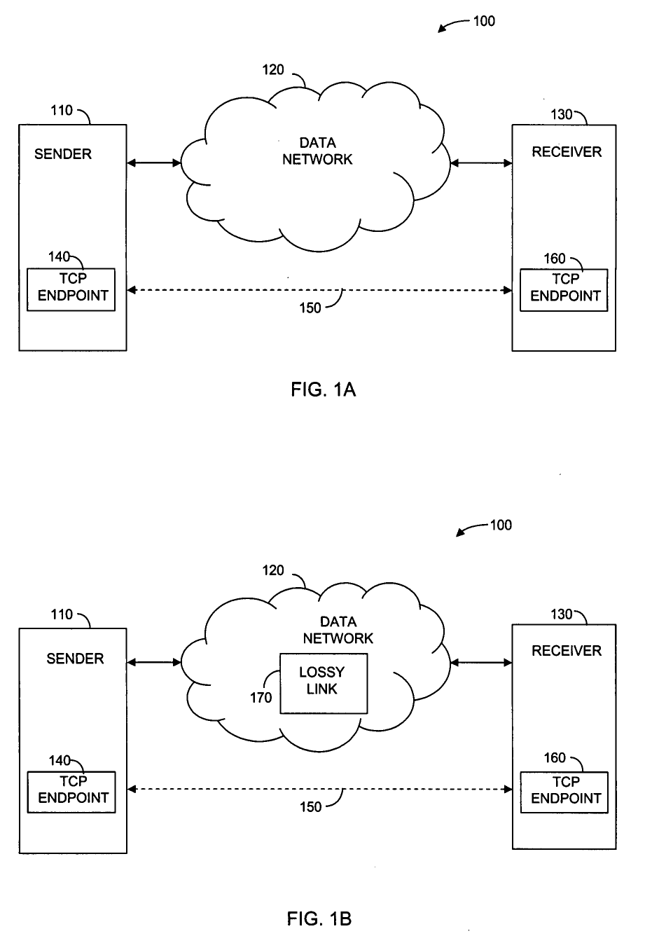

FIG. 1A depicts an exemplary system 100 in which one or more aspects of the invention may be implemented. The system 100 consists of a sender 110 in communication with a receiver 130 over a data network 120.

Sender 110 may be a network node adapted to create a TCP virtual circuit 150 with another device through the use of one or more TCP modules resident on sender 110. For example, a sender 110 may be a desktop computer, a laptop computer, a cellular telephone, a Personal Digital Assistant (PDA), a server, a network adapter, or an embedded computer. It should be appreciated that the above list is exemplary only, as any device capable of creating a TCP virtual circuit 150 with another device may be considered a sender 110. A TCP module may be part of a Transmission Control Protocol/Internet Protocol (TCP/IP) stack shared by more than one program on sender 110 or it may exist as part of another program. In addition, it should be appreciated that a sender 110 that contains a TCP module consistent with the principles of the invention may further contain other TCP modules that are not configured as such.

In the embodiment of FIG. 1A, a TCP virtual circuit 150 exists between sender TCP endpoint 140 and receiver TCP endpoint 160. The concepts of a TCP virtual circuit and TCP endpoints are well known in the art and need not be explained in this application. However, they are displayed on FIG. 1A to illustrate that a reliable TCP session, with its attendant flow control algorithms, may be created between sender 110 and receiver 130, even if the underlying network protocols and networks are unreliable. It should be understood that more than one TCP virtual circuit 150 between sender 110 and receiver 130 may exist simultaneously.

Data network 120 may consist of a single network or multiple interconnected networks. Examples of networks that may make up data network 120 include the Internet, local area networks, wide area networks, digital subscriber line (DSL) networks, cable networks, dial-up networks, satellite networks and cellular data networks. The networks may be wired or wireless. They may also be packet-switched networks or circuit-switched networks. The above list of networks that may make up data network 120 is exemplary only and it should be appreciated that any network that may be connected to another network through the use of one or more network layer protocols, such as the Internet Protocol (IP), may be used.

Receiver 130 may be a network node adapted to create a TCP virtual circuit 150 with another device through the use of one or more TCP modules resident on receiver 130. For example, a receiver 130 may be a desktop computer, a laptop computer, a cellular telephone, a Personal Digital Assistant (PDA), a server, a network adapter, or an embedded computer. It should be appreciated that the above list is exemplary only as any device capable of creating a TCP virtual circuit 150 with another device may be considered a receiver 130. A TCP module may be part of a TCP/IP protocol stack shared by more than one software program on receiver 130 or it may exist as part of another software program. In addition, it should be appreciated that a receiver 130 that contains a TCP module consistent with the principles of the invention may further contain other TCP modules that are not configured as such.

While units 110 and 130 in FIG. 1A have been described as “sender” and “receiver” respectively, it should be appreciated that these terms are arbitrary and that sender 110 may at times be transmitting data to receiver 130, while at other times, receiver 130 may be transmitting data to sender 110.

FIG. 1B depicts another embodiment of a system 100 in which one or more of the data networks that comprise data network 120 contain a lossy link 170. While in the embodiment shown in FIG. 1B, network 120 contains only one lossy link 170, it should be appreciated that network 120 may contain more than one lossy link 170.

According to one embodiment, a lossy link 170 may consist of a data-link with a high packet loss probability. In addition to having a high packet loss probability, a lossy link 170 may be adapted to use a protocol containing a form of Automatic Repeat request (ARQ) to compensate for packet loss.

High packet loss probability may be considered any probability of packet loss that may cause TCP to use one of its congestion control methods in the absence of actual network congestion. For example, a packet loss probability of 1% may be considered a high packet loss probability, whereas a packet loss probability of 0.001% may not be. These numbers are for exemplary purposes only and should not be considered a limitation on the invention. Packet loss may be defined as loss of a packet due to damage to its contents while in transit over a network, such as bit errors, and should be contrasted with loss of a packet due to packet destruction by a router.

Examples of protocols that use a form of ARQ are the Radio Link Protocol (RLP) and the various type I and type II hybrid ARQ (HARQ) protocols. In addition, certain dial-up networking protocols use a form of ARQ. Any protocol that may be considered a lower level protocol than TCP (such as a network, data-link, or physical layer protocol) and provides for retransmission of a corrupted packet, independent of TCP's retransmission algorithms, may be considered a protocol that uses a form of ARQ.

Examples of networks that may include one or more of a lossy link 170 are dial-up networks and cellular data networks, such as Code Division Multiple Access 2000 (CDMA2000) networks, General Packet Radio Services (GPRS) networks, Universal Mobile Telecommunications System (UMTS) networks, Universal Terrestrial Radio Access Networks (UTRAN), and Enhanced Data for GSM Evolution (EDGE) networks. This list is for explanatory purposes only, and should not be considered limiting on the invention as any network that contains a lossy link 170 is equally valid.

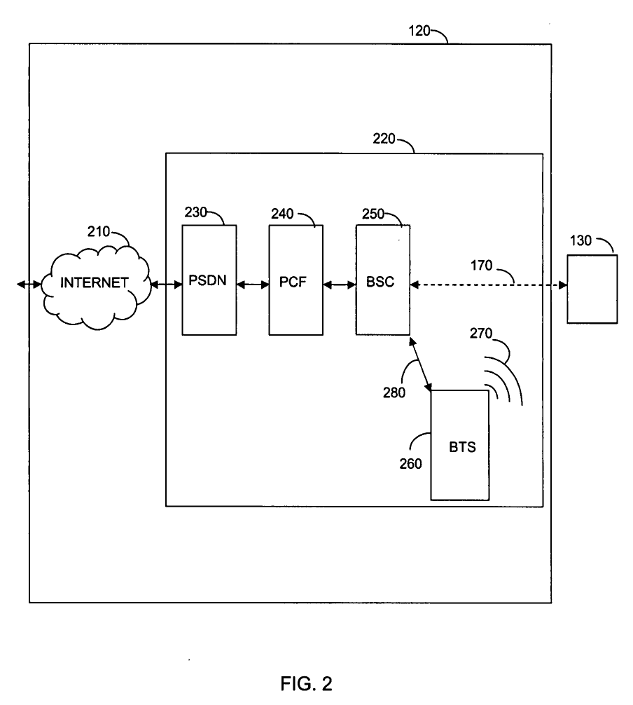

FIG. 2 depicts certain aspects of a data network 120 that contains a lossy link 170, according to one embodiment of the invention. In this embodiment, network 120 consists of the Internet 210 and a CDMA2000 network 220. CDMA2000 network 220 includes a Packet Switched Data Node (PSDN) 230, a Packet Control Function (PCF) 240, a Base Station Controller (BSC) 250, a Base Transceiver Station (BTS) 260, and the connections between these components. The depiction of the CDMA2000 network 220 in FIG. 2 is a simplified depiction and it should be understood that a CDMA2000 network 220 may contain other components not shown in FIG. 2 and/or multiple units of each of the components shown in FIG. 2.

Lossy link 170 in the embodiment displayed in FIG. 2 is the data-link between BCS 250 and receiver 130. The physical links that make up the data-link in this embodiment are the wired connection 280 between BCS 250 and BTS 260 and the wireless connection 270 between BTS 260 and receiver 130. Due to the wireless connection 270 between BTS 260 and receiver 130, lossy link 170 may have a high packet loss probability. Furthermore, lossy link 170 is adapted to use RLP to compensate for any high packet loss probability, as is specified in the CDMA2000 standard. Again, while FIG. 2 is described in terms of a CDMA2000 network 220, any network 220 that contains a lossy link is equally valid.

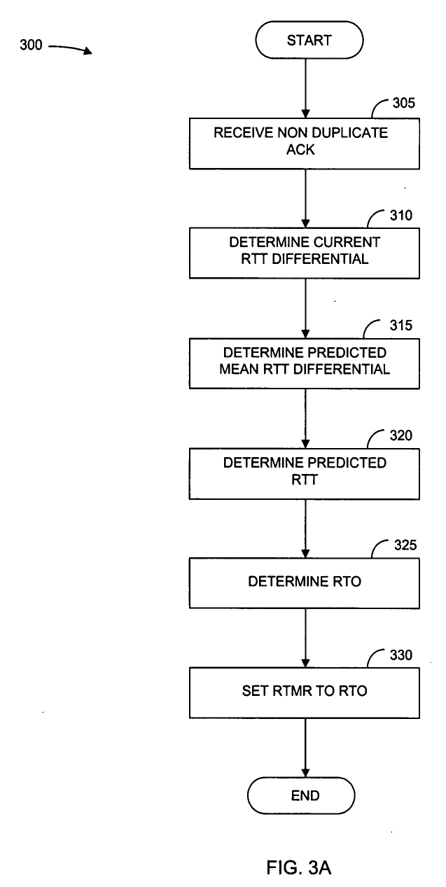

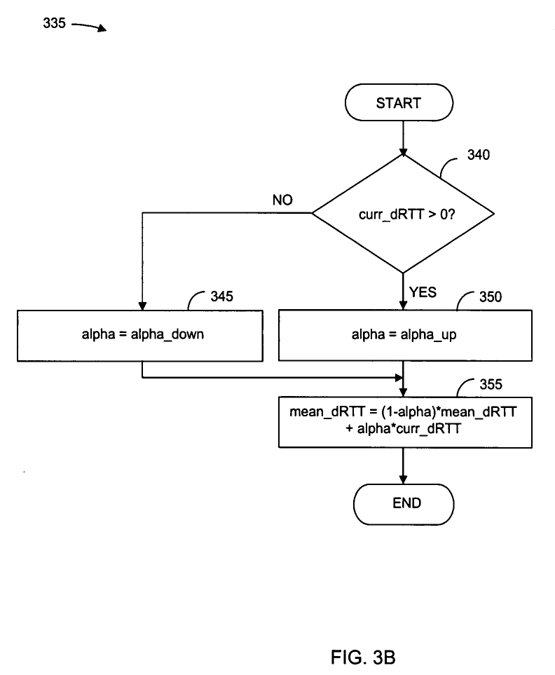

FIG. 3A depicts one embodiment of a process 300 for setting the retransmission timer (RMTR) for a TCP session. Timer process 300 may be implemented in one or more TCP modules in a network node. The network node may at times be a sender (e.g. sender 110) and at other times a receiver (e.g. receiver 130)

Process 300 begins at block 305 when a non-duplicate acknowledgment (NDACK) is received by a TCP module in a sender in response to a segment that was previously transmitted. An NDACK is an acknowledgment (ACK) that has been transmitted by a TCP module in a receiver in response to the receipt of an in-order segment from a sender. A duplicate ACK (DACK), on the other hand, is an ACK sent by a TCP module in a receiver in response to the receipt of an out-of-order segment. For example, if a receiver receives segment 1 before receiving any other segment, it will send out an NDACK for segment 1. If a receiver then receives segment 3 before receiving segment 2, it will send out a DACK. It should be appreciated that an NDACK received by the sender in block 1 may also be a delayed ACK as the term in known in the art.

Process 300 proceeds to block 310 where the current round trip time differential (curr_dRTT) is calculated. In one embodiment, curr_dRTT may be calculated as the round trip time (RTT) of a segment associated with the NDACK received in block 305 minus a previously determined RTT of a segment associated with a previously received NDACK (prev_RTT). The RTT of a segment may be the elapsed time between the transmission of a segment from a sender and the receipt of its corresponding NDACK, however, any consistent method to determine the RTT of a segment may be used. It may be expressed in units of time, clock cycles or any other suitable timing parameter. It should be appreciated that if only one NDACK has been received during the current TCP session, then prev_RTT may equal zero.

Still referring to FIG. 3A, process 300 moves to block 315 where the predicted mean RTT differential (mean_dRTT) is determined. In certain embodiments, mean_dRTT may be determined using a process based on stationary process modules such as the Least Mean Square (LMS) and Recursive Least Squares (RLS) methods. These prediction methods are for exemplary value only and should not be read as a limitation on the invention.

FIG. 3B depicts one embodiment of a process 335 to determine mean_dRTT. Prediction process 335 begins at block 340, where a determination of the sign of curr_dRTT is made. If curr_dRTT is positive, process 335 moves to block 350 where a weight factor alpha is set to the value of alpha_up. If, however, curr_dRTT is negative then process 335 moves to block 345 where alpha is set to the value of alpha_down. If curr_dRTT is neither negative or positive (i.e. curr_dRTT=0), process 335 may proceed to block 345 in one embodiment, or block 350 in another embodiment.

The values for alpha_up and alpha_down may vary from one TCP session to another. They may be calculated in light of measurements and modeling of the packet loss probabilities and corruption characteristics of a particular network (e.g. network 120) over which a TCP virtual circuit (e.g. TCP virtual circuit 150) is established. For example, an alpha_up/alpha_down pair for a TCP session established over a network that includes one or more lossy links (e.g. lossy link 170) may differ from an alpha_up/alpha_down pair for a TCP session established over a network that does not include a lossy link. It should also be appreciated that an alpha_up/alpha_down pair for a TCP session established over a network that includes at least one type of lossy link may differ from an alpha_up/alpha_down pair for a TCP session established over a network that includes at least one of another type of lossy link. For example, an alpha_up/alpha_down pair for a TCP session established over a network that includes a lossy link that uses an RLP protocol may differ from an alpha_up/alpha_down pair for a TCP session established over a network that includes a lossy link that uses a HARQ protocol.

In one embodiment, alpha_up and alpha_down may be adjustable by the user of a network node that contains a TCP module consistent with the principles of the invention. In another embodiment, alpha_up and alpha_down may be adjustable by another party. For example, the values of alpha_up and alpha_down in a TCP module on a cellular phone may be adjustable over the cellular network by the operator of the cellular network or a software vendor.

It should also be appreciated that in another embodiment, the values of alpha_up and alpha_down may not be constant during a TCP session. For example, alpha_up and alpha_down may vary within a predetermined range based on the value of curr_dRTT. In another embodiment, alpha_up and alpha_down in a receiver may be changed by a sender before, during or after a TCP session, or vice-versa.

Still referring to the embodiment displayed in FIG. 3B, mean_dRTT is determined at block 355 according to the relation: mean_dRTT=(1×alpha)*mean_dRTT(old)+alpha*curr_dRTT, where mean_dRTT(old) is a stored, previously determined mean_dRTT. It should be appreciated that if only one NDACK has been received in the TCP session, the value of mean_dRTT(old) used in the above equation may be zero.

Referring back to FIG. 3A, after determining mean_dRTT, process 300 proceeds to block 320 where the predicted RTT of the next segment to be transmitted (pred_RTT) is determined. In one embodiment, pred_RTT may be determined according to the relation: pred_RTT=pred_RTT(old)+mean_dRTT, where pred_RTT(old) is a stored, previously determined pred_RTT.

At block 325, the retransmission timeout (RTO) for the next segment to be transmitted is determined. In one embodiment, RTO may be determined as the value of pred_RTT plus a safety factor (SF). SF may be a constant value, or it may be a function of another value. In certain embodiments, SF may be determined as the maximum curr_dRTT (max_dRTT) observed in the TCP session to that point, multiplied or divided by a constant such as 2, 3, etc.

At block 330, RMTR is set to the value of RTO. Thereafter, RMTR may be used by the TCP session to determine whether a data segment has been lost. For example, in one embodiment, upon the transmission of a new data segment, RMTR may be started. If it reaches zero before an NDACK for that segment is received, then the segment may be presumed lost.

While timer process 300 and prediction process 335 have been described in the above embodiments, it should be appreciated that these are for exemplary value only and other embodiments are applicable to the current invention.

For the sake of simplicity, processes 300 and 335 have been defined as general acts and it should be appreciated that other acts consistent with the principles of the invention may be included, such as determining max_dRTT. In addition, it should be equally appreciated that processes 300 and 335 may exist in a TCP module alongside other processes running concurrently with processes 300 and 335. As such, the acts performed in process 300 or in process 335 may at times be interspersed or replaced with acts performed in other processes. For example, upon an RTMR timeout, RMTR may be set using a method described as Karn's algorithm. Karn's algorithm specifies that RTO is to be doubled upon an RTMR timeout. Other implementations of TCP may contain similar methods that specify that RTO is to be fractionally increased upon an RMTR timeout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for setting a Transmission Control Protocol (TCP) retransmission timer for a TCP session, comprising the acts of:
determining a current round trip time differential for the TCP session based at least in part on a round trip time of one or more data segments wherein said one or more data segments are associated with a non-duplicate acknowledgment;
determining a predicted mean round trip time differential for the TCP session based at least in part on said current round trip time differential;
determining a predicted round trip time for a data segment based at least in part on said predicted mean round trip time differential;
determining a retransmission timeout for the TCP session based at least in part on said predicted round trip time and a safety factor; and
setting the TCP retransmission timer to the retransmission timeout.

2. The method of claim 1, wherein said data network contains one or more lossy links.

3. The method of claim 1, wherein determining the current round trip time differential (curr_dRTT) comprises determining the curr_dRTT according to the relation:
curr_dRTT=(curr_RTT−prev_RTT),
where curr_RTT is the round trip time of said one or more data segments and prev_RTT is a stored round trip time of one or more previous data segments associated with a previous non-duplicate acknowledgment received prior to said non-duplicate acknowledgment.

4. The method of claim 1, wherein determining the predicted mean round trip time differential (mean_dRTT) comprises determining the mean_dRTT according to the relation:
mean_dRTT=(1−alpha)*mean_dRTT(old)+alpha*curr_dRTT,
where mean_dRTT(old) represents a stored predicted mean round trip time differential, alpha represents a weight factor, and curr_dRTT represents the current round trip time differential.

5. The method of claim 4, further comprising the act of determining alpha wherein alpha is set to a first value if said curr_dRTT is negative and wherein alpha is set to a second value if said curr_dRTT is positive.

6. The method of claim 5, wherein said first value and said second value are adjustable.

7. The method of claim 1, wherein determining the predicted round trip time (pred_RTT) comprises determining the pred_RTT according to the relation:
pred_RTT=pred RTT(old)+mean_dRTT, where mean_dRTT represents the predicted mean round trip time differential and pred RTT(old) represents a stored predicted round trip time.

8. The method of claim 1, wherein determining the retransmission timeout (RTO) comprises determining the RTO according to the relation:
RTO=pred_RTT+SF,
where pred_RTT is the predicted round trip time and SF is the safety factor.

9. The method of claim 8, wherein SF is a function of a maximum round trip time differential of the TCP session.

10. A computer program product comprising:
a computer readable medium having computer executable program code embodied therein to set a Transmission Control Protocol (TCP) retransmission timer of a TCP session, the computer executable program code having:
computer executable program code to determine a current round trip time differential for the TCP session based at least in part on a round trip time of one or more data segments wherein said one or more data segments are associated with a non-duplicate acknowledgment;
computer executable program code to determine a predicted mean round trip time differential for the TCP session based at least in part on said current round trip time differential;
computer executable program code to determine a predicted round trip time for a data segment based at least in part on said predicted mean round trip time differential;
computer executable program code to determine a retransmission timeout for the TCP session based at least in part on said predicted round trip time and a safety factor; and
computer executable program code to set the TCP retransmission timer to the retransmission timeout.

11. The computer program product of claim 10, wherein said data network contains one or more lossy links.

12. The computer program product of claim 10, wherein said computer executable program code to determine the current round trip time differential (curr_dRTT) comprises computer executable program code to determine the curr_dRTT according to the relation:
curr_dRTT=(curr_RTT−prev_RTT),
where curr_RTT is the round trip time of said one or more data segments and prev_RTT is a stored round trip time of one or more previous data segments associated with a previous non-duplicate acknowledgment received prior to said non-duplicate acknowledgment.

13. The computer program product of claim 10, wherein said computer executable program code to determine the predicted mean round trip time differential (mean_dRTT) comprises computer executable program code to determine the mean_dRTT according to the relation:
mean_dRTT =(1−alpha)*mean_dRTT(old)+alpha*curr_dRTT,
where mean_dRTT(old) represents a stored predicted mean round trip time differential, alpha represents a weight factor, and curr_dRTT represents the current round trip time differential.

14. The computer program product of claim 13, further comprising computer executable program code to determine alpha wherein alpha is set to a first value if the curr_dRTT is negative and wherein alpha is set to a second value if the curr_dRTT is positive.

15. The computer program product of claim 14, further comprising computer executable program code to adjust one or more of said first value and said second value.

16. The computer program product of claim 10, wherein said computer executable program code to determine the predicted round trip time (pred_RTT) comprises computer executable program code to determine the pred_RTT according to the relation:
pred_RTT=pred_RTT(old)+mean_dRTT,
where mean_dRTT represents the predicted mean round trip time differential and pred_RTT(old) represents a stored predicted round trip time.

17. The computer program product of claim 10, wherein said computer executable program code to determine the retransmission timeout (RTO) comprises computer executable program code to determine the RTO according to the relation:
RTO=pred_RTT+SF,
where pred_RTT is the predicted round trip time and SF is the safety factor.

18. The computer program product of claim 17, wherein SF is a function of a maximum round trip time differential of the TCP session.

19. A network node comprising:
a network interface adapted to provide connectivity to a data network;
a processor coupled to said network interface; and
a memory coupled to said processor, said memory containing processor executable instruction sequences to cause the network node to:
determine a current round trip time differential for the TCP session based at least in part on a round trip time of one or more data segments wherein said one or more data segments are associated with a non-duplicate acknowledgment,
determine a predicted mean round trip time differential for the TCP session based at least in part on said current round trip time differential,
determine a predicted round trip time for a data segment based at least in part on said predicted mean round trip time differential,
determine a retransmission timeout for the TCP session based at least in part on said predicted round trip time and a safety factor, and
set the TCP retransmission timer to the retransmission timeout.

20. The network node of claim 19, wherein said data network contains one or more lossy links.

21. The network node of claim 19, wherein said memory further includes processor executable instruction sequences to cause the network node to determine the current round trip time differential (curr_dRTT) according to the relation:
curr_dRTT=(curr_RTT−prev_RTT),
where curr_RTT is the round trip time of said one or more data segments and prev_RTT is a stored round trip time of one or more previous data segments associated with a previous non-duplicate acknowledgment received prior to said non-duplicate acknowledgment.

22. The network node of claim 19, wherein said memory further includes processor executable instruction sequences to cause the network node to determine the predicted mean round trip time differential (mean_dRTT) according to the relation:
mean_dRTT=(1−alpha)*mean_dRTT(old)+alpha*curr_dRTT,
where mean_dRTT(old) represents a stored predicted mean round trip time differential, alpha represents a weight factor, and curr_dRTT represents the current round trip time differential.

23. The network node of claim 22, wherein said memory further contains processor executable instruction sequences to determine alpha wherein alpha is set to a first value if the curr_dRTT is negative and wherein alpha is set to a second value if the curr_dRTT is positive.

24. The network node of claim 23, wherein said memory further contains processor executable instructions to adjust one or more of said first value and said second value.

25. The network node of claim 19, wherein said memory further includes processor executable instruction sequences to cause the network node to determine the predicted round trip time (pred_RTT) according to the relation:
pred_RTT=pred_RTT(old)+mean_dRTT,
where mean_dRTT represents the predicted mean round trip time differential and pred_RTT(old) represents a stored predicted round trip time.

26. The network node of claim 19, wherein said memory further includes processor executable instruction sequences to cause the network node to determine the retransmission timeout (RTO) according to the relation:
RTO=pred_RTT+SF,
where pred_RTT is the predicted round trip time and SF is the safety factor.

27. The network node of claim 26, wherein SF is a function of a maximum round trip time differential of the TCP session.
